(19) United States
(12) Patent Application Publication
(10) Pub. No.: US 2009/0019469 A1
(43) Pub. Date: Jan. 15, 2009

(54) DYNAMIC UPDATE OF CHANNEL FILTERING INFORMATION IN IPTV SYSTEMS

(75) Inventors: George Foti, Dollard-des-Ormeaux (CA); Alain Boudreau, Le Gardeur (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/776,202

(22) Filed: Jul. 11, 2007

(51) Int. Cl. H04N 7/16

(52) U.S. Cl. 725/27

(57) ABSTRACT

Systems and methods according to the present invention address this need and others by updating the channel filtering information, e.g., whitelist, within the context of a streaming media system, e.g., an IMS-IPTV system. This updating of the channel filtering information occurs automatically through messages transmitted between a network node and an Internet Protocol television (IPTV) control function including intervening hardware.

### TECHNICAL FIELD

The present invention relates generally to telecommunications systems and in particular to methods and systems for dynamically updating channel filtering information (e.g., a subscriber's whitelist) in IPTV systems.

### BACKGROUND

As the level of technology increases, the options for communications have become more varied. For example, in the last 30 years in the telecommunications industry, personal communications have evolved from a home having a single rotary dial telephone, to a home having multiple telephone, cable and/or fiber optic lines that accommodate both voice and data. Additionally cellular phones and Wi-Fi have added a mobile element to communications. Similarly, in the entertainment industry, 30 years ago there was only one format for television and this format was transmitted over the air and received via antennas located at homes. This has evolved into both different standards of picture quality, such as standard definition TV (SDTV), enhanced definition TV (EDTV) and high definition TV (HDTV), and more systems for delivery of these different television display formats such as cable and satellite. Additionally, services have grown to become overlapping between these two industries. As these systems continue to evolve in both industries, the service offerings will continue to merge and new services can be expected to be available for a consumer. Also these services will be based on the technical capability to process and output more information, for example as seen in the improvements in the picture quality of programs viewed on televisions, and therefore it is expected that service delivery requirements will continue to rely on more bandwidth being available throughout the network including the “last mile” to the end user.

Another related technology that impacts both the communications and entertainment industries is the Internet. The physical structure of the Internet and associated communication streams have also evolved to handle an increased flow of data. Servers have more memory than ever before, communications links exist that have a higher bandwidth than in the past, processors are faster and more capable and protocols exist to take advantage of these elements. As consumers' usage of the Internet grows, service companies have turned to the Internet (and other Internet Protocol (IP) networks) as a mechanism for providing traditional services. These multimedia services include Internet Protocol television (IPTV, referring to systems or services that deliver television programs over a network using IP data packets), video on demand (VOD), voice over IP (VoIP), and other web related services received singly or bundled together.

To accommodate the new and different ways in which IP networks are being used to provide various services, new network architectures are being developed and standardized. One such development is the Internet Protocol Multimedia Subsytem (IMS). IMS is an architectural framework for delivering IP multimedia services, such as IPTV, to an end user. IMS can be considered to have three separate layers: (1) the control layer; (2) the service layer; and (3) the connectivity layer. The control layer is a horizontal layer which separates the service layer from the connectivity layer thereby enabling IMS architectures to support different access networks independently of the services/applications being provided to end users. The service layer can include such elements as application servers which can provide media and other desired services, the connectivity layer could be either an IP network and/or the public switched telephone network (PSTN) which connects to end users, and the control layer can be considered to contain the IMS core which includes such elements as the home subscriber server (HSS) and the call session control function (CSCF). A more detailed example of an IMS architecture is provided below.

As the use of IMS-IPTV grows, the subscription options and user choices are also expected to grow in number. An integral part of allowing a subscriber access to his or her subscribed media within an IMS-IPTV system is the channel filtering information also sometimes known as a “subscriber whitelist”. Generally, a whitelist can be described as a subset or a list of confirmed acceptable items within a set or larger quantity of items. This whitelist can also considered to be a filter, because only options that are in the whitelist are passed through to the next process or device. By way of contrast to a whitelist, a blacklist can be described as a subset or a list of confirmed unacceptable items within a set or larger quantity of items. Within the context of IPTV the phrase “subscriber whitelist” can be considered to be the list of authorized broadcast channels that a consumer premise equipment (CPE), e.g., a set-top box or TV, is currently authorized to access from a service provider.

As shown in FIG. 1, an exemplary whitelist in the IPTV environment can contain information describing a digital subscriber line (DSL) port 102, a permanent virtual circuit (PVC) 104, and an IP Multicast Range 106. The whitelist shown in FIG. 1 can be used as a filter for allowing different users to access different channels. For example, if the equipment attached to DSL port 1 (108 and 110) attempted to access channel A (112 and 114) access would be granted. However, if the equipment attached to DSL port 1 (108 and 110) attempted to access channel B, access would be denied since channel B is not shown to be in the allowed IP Multicast Range for DSL port 1 as shown in boxes 112 and 114. It is to be understood that the exemplary whitelist shown in FIG. 1 is purely illustrative and could be created to contain more, less, or different information. For example, the IP Multicast Range could be shown in another format such as a traditional IP address range like 226.68.89.57-226.68.89.59. As used herein, the phrase “channel filtering information” is intended to encompass this type of information (as well as other types) used to filter IPTV channels whether it is applied as a whitelist, a blacklist or in some other way, e.g., a grey list which is a list of channels which require operator policy to be considered before accepting or rejecting a user request.

The subscriber whitelist typically contains a subset of the entire list of broadcast channels that an IPTV service provider can offer to its subscriber base. In operation, the network typically verifies whether a user is authorized to view a particular channel or service when the user selects that channel or service to view and prior to streaming the selected media to the CPE. The whitelist can be stored on various nodes in a network, and can be provisioned to store or update values such as those shown in FIG. 1 using various methods. For example, the whitelist is typically manually provisioned through techniques such as those used in operations support systems (OSS) thereby requiring the IPTV service provider and/or connectivity partner (such as, for example, any organization that owns the network parts, such as the communication links and modems) to manually configure the list with updates. This manual method is often done remotely, through intervention by an operator, to provision the list in, for example, the digital subscriber line access multiplexer (DSLAM) node which is usually the closest node to the subscriber. This manual process is inefficient, particularly since it needs to be done for a large number of subscribers (1) upon initially getting IPTV service, (2) on an ongoing basis when subscribers change their respective whitelist as their preferences change, and (3) when the options provided by the various IPTV service providers change. An additional complication results when the service provider is not the same as the communications carrier (or connectivity partner), because they do not necessarily have a mechanism for efficiently communicating a subscriber's whitelist from the service provider to the desired node close to the CPE, such as a DSLAM node.

Accordingly exemplary embodiments described below address the need for improving the efficiency of updating the channel filtering information, e.g., whitelist, within the context of an IMS-IPTV system.

### SUMMARY

Systems and methods according to the present invention address this need and others by providing techniques for dynamically updating the channel filtering information, e.g., whitelist, within the context of an IMS-IPTV system.

According to one exemplary embodiment a method for communicating channel filtering information for a streaming media system includes determining that a predetermined channel filtering event has occurred; transmitting, responsive to the determining, from a streaming media application server, the channel filtering information; and receiving and storing the channel filtering information in a node of the streaming media system.

According to another exemplary embodiment a node includes a processor in communications with a memory unit, wherein the processor receives a message including channel filtering information and stores the channel filtering information in the memory unit.

According to yet another exemplary embodiment a node includes a processor in communications with a memory unit, wherein the processor receives an indication that a predetermined channel filtering information event has occurred, further wherein the processor transmits a message including channel filtering information.

### BRIEF DESCRIPTION OF THE DRAWINGS

The accompanying drawings illustrate exemplary embodiments, wherein:

FIG. 1 shows a whitelist according to exemplary embodiments;

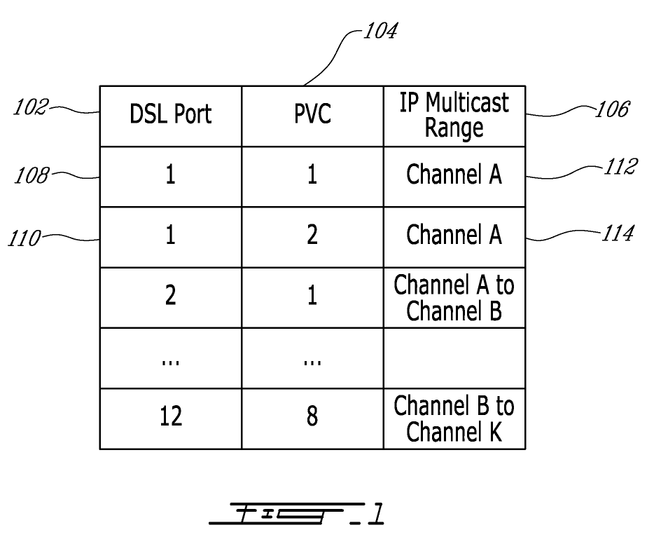

FIG. 2 illustrates a portion of a telecommunications system according to exemplary embodiments;

FIG. 3 shows a messaging sequence for initially populating a whitelist according to exemplary embodiments;

FIG. 4 shows a messaging sequence for dynamically updating a whitelist according to exemplary embodiments;

FIG. 5 depicts a server according to exemplary embodiments; and

FIG. 6 shows a flowchart for a method for communicating channel filtering information according to exemplary embodiments.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

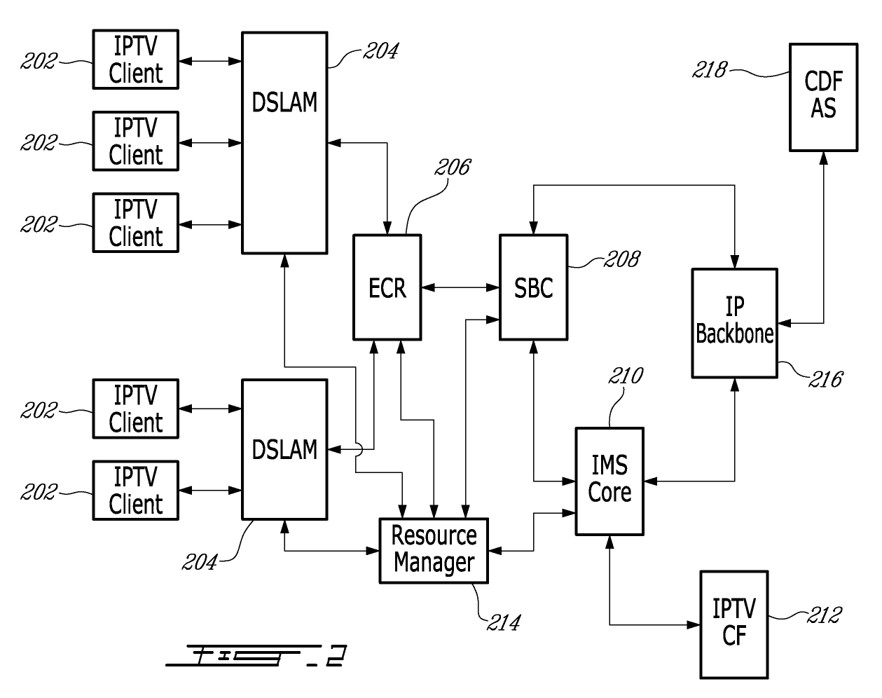

In order to provide some context within which exemplary embodiments will be better understood, consider the exemplary portion of a communication network illustrated as FIG. 2. It will be appreciated by those skilled in the art that this example is purely illustrative and that exemplary embodiments may be implemented in many types of networks other than the example provided as FIG. 2. Therein, the portion of the communication network associated with delivering media over an IMS system to individual pieces of user equipment, such as a set-top box acting as an Internet Protocol television (IPTV) client, is described.

To briefly step through the exemplary network structure illustrated in FIG. 2, a number of IPTV clients 202, sometimes also referred to as “user equipments (UEs)” or “consumer premise equipments (CPEs)”, are connected to the network through digital subscriber line access multiplexers (DSLAMs) 204. The DSLAMs 204 multiplex signals from the CPEs 202 together and load them onto the network via an edge collect router (ECR) 206. Communications between the end user and the network are passed between the ECR 206 which can act as the edge of the access network to the end user and a session border controller (SBC) 208 which can provide assistance in session setup and control across network borders. The SBC 208 is in communication with a Resource Manager 214, the IMS Core 210 and the IP Backbone 216. An example of a Resource Manager 214 is an Access Resource and Admission Control Function (ARACF) which is the functional entity of the Resource Admission Control Subsystem (RACS) and specified within the Telecoms & Internet converged Services and Protocols for Advanced Networks (TISPAN) standards, however it will be appreciated by those skilled in the art that other types of resource management entities can be used in conjunction with exemplary embodiments. The A-RACF functional entity, among other things, receives information about the IP address allocated to a particular user and maps that IP allocation to physical resources in the access network. IMS Core 210 contains the IMS core functions such as the home subscriber server (HSS) and the call session control function (CSCF). Additionally, IMS Core 210 is in communications with both the Resource Manager 214 and the IPTV Control Function (CF) 212. The IPTV CF 212 is a control server used in managing IPTV subscriber services. IP Backbone 216 is in communications with the SBC 208 and the content delivery function application server (CDF AS) 218. IP Backbone 216 contains such equipment as routers, switches and nodes to facilitate communications and to transfer information. CDF AS 218 contains the desired media or service to be delivered to the IPTV clients 202 and there typically will be a number of such servers 218.

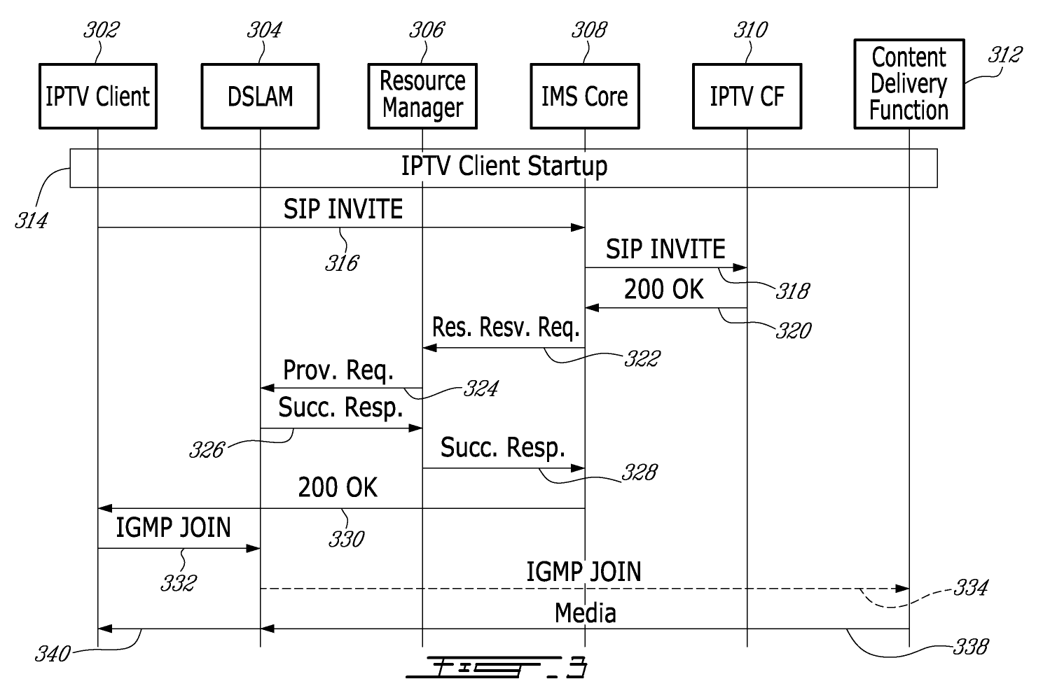

IPTV programs can be transmitted to a plurality of subscribers from a plurality of service providers over a system such as that shown in FIG. 2. For an end user to use the services for which he or she is subscribed to, channel filtering information, e.g., a whitelist, needs to be initially provisioned for that subscriber. An exemplary method for initially provisioning channel filtering information for a subscriber is described below using the message flows as shown in FIG. 3.

FIG. 3 illustrates an exemplary sequence of messages used to initially provision channel filtering information for a subscriber upon powering up an IPTV client device. This process can occur using the exemplary architecture described in FIG. 2. Initially, the IPTV client 302 is powered up as seen in box 314. The IPTV client 302 reserves resources used for broadcast IPTV by transmitting a Session Initiation Protocol (SIP) INVITE to the IPTV Control Function 310 via the IMS Core 308 (messages 316 and 318). The IPTV CF 310 responds to the IMS core 308 with a 200 OK message 320, which includes, among other information, the Quality of Service (QoS) information and the channel filtering information, e.g., a whitelist, associated with this particular subscriber and/or IPTV client device. For example, the channel filtering information can be provided in the Session Description Protocol (SDP) part of the SIP 200 OK message. More information relating to SIP signaling and SDP can be found in RFC 3261 dated June 2002 and RFC4 4566 dated July 2006 respectively, both of which are incorporated herein by reference.

The IMS Core 308 then transmits resource reservation request message 322, including the channel filtering information, to the Resource Manager 306. The Resource Manager 306 stores the channel filtering information, and then transmits a provisioning request 324 to the DSLAM 304 associated with the user. The DSLAM 304 stores the channel filtering information and transmits a success response message 326 to the Resource Manager 306. The Resource Manager 306 then forwards the success response message 328 to the IMS Core 308. The IMS Core 308 then forwards the 200 OK as message 330 to the IPTV Client 302.

At this point, the user selects a TV channel for viewing, which then prompts the IPTV client 302 to transmit an Internet Group Management Protocol (IGMP) JOIN message 332 to the DSLAM 304 i.e., requesting that this particular UE be allowed to join a multicast IPTV program stream. The DSLAM 304 verifies whether the selected channel is authorized for this particular subscriber using the channel filtering information, e.g., by comparing it with that user's whitelist. If the selected channel is authorized, the DSLAM replicates the stream if available at the DSLAM, or the DSLAM forwards the IGMP JOIN request to an upstream server that may have the stream such as the Content Delivery Function 310. The media available on the selected channel, e.g., a multicast IPTV program, then starts flowing from the Content Delivery Function 312 to the DSLAM 306 and on to the IPTV Client 302 as shown by messages 338 and 340, respectively.

This initial provisioning of the channel filtering information, e.g., a whitelist, allows a subscriber to access any channel or service he or she has subscribed to while blocking unauthorized IPTV channels without requiring manual provisioning of the channel filtering information. Over time, the channel filtering information will typically need to be updated as either the subscriber changes his or her subscription with the service provider, or the service provider makes changes to, e.g., the channels provided. However, there is no need for the connectivity partner to manually provision the subscriber's DSLAM with the updated whitelist because the whitelist can be pushed through the communications network from the IPTV CF 310 to the DSLAM 306 according to other exemplary embodiments as described below.

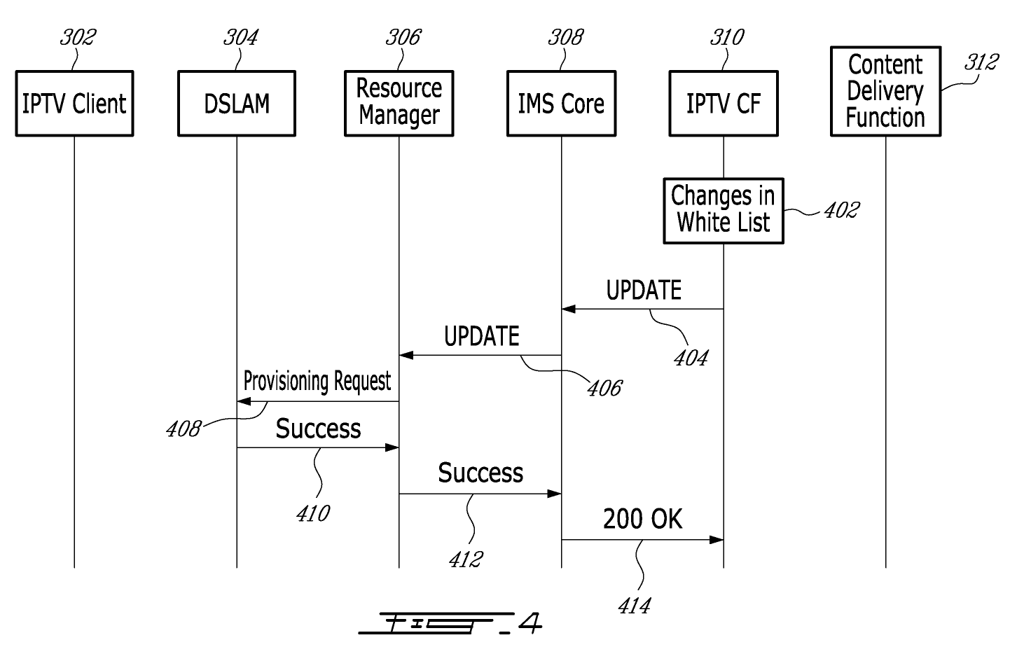

As the need to modify the channel filtering information e.g., a whitelist, of a subscriber manifests itself due to e.g., a change in the potential channel options, an exemplary method for dynamically updating the channel filtering information can be performed as described with respect to FIG. 4. The same parts of the system as described in FIG. 3 i.e., (the IPTV Client 302, the DSLAM 304, the Resource Manager 306, the IMS Core 308, IPTV CF 310 and Content Delivery Function 312) are also shown in FIG. 4, however neither the IPTV Client 302 nor the Content Delivery Function 312 are typically used in updating a subscriber's whitelist and are only shown in FIG. 4 for continuity. Initially, the IPTV CF 310 becomes aware of a change in a user's whitelist 402, which then triggers sending an UPDATE message 404 from the IPTV CF 310 to the IMS Core 308 for the broadcast session. The UPDATE message 404 is an existing type of SIP message (RFC 3311) which is used within the context of a SIP dialog to report to a peer changes in the description of the SIP session. In this application the whitelist is considered to be part of the session description information which allows for a change in the whitelist to be reported using the UPDATE message 404.

Among other information, the UPDATE message 404 can contain the new channel filtering information (either the changes only or a completely updated whitelist) and any other QoS information as desired. After receiving the UPDATE message 404, the IMS Core transmits an update message 406 to the Resource Manager 306. The Resource Manager 306 updates its internal state with the new whitelist and then transmits a new provisioning request message 408 containing the channel filtering information to the DSLAM 304. Upon a successful update by the DSLAM 304 of its whitelist, the DSLAM 304 transmits a success message 410 to the Resource Manager 306 indicating a successful update to the DSLAM's 304 whitelist. The Resource Manager 306 then sends a success message 412 to the IMS Core 312 indicating that both the Resource Manager 306 and the DSLAM 304 have successfully updated their respective whitelists. The IMS Core 308 completes the update process by transmitting a 200 OK message 414 to the IPTV CF 310 indicating success in the whitelist updating process.

In the foregoing exemplary embodiments, the channel filtering information was transmitted to the various nodes of interest (e.g., DSLAM and Resource Manager) via a 200 OK message or an UPDATE message. However, the present invention is not limited thereto and the channel filtering information can be sent using other signaling mechanisms. For example, according to other exemplary embodiments, the channel filtering information can be transmitted as part of the messaging scheme associated with a variety of neighbor discovery protocols. For example, the channel filtering information could be transmitted as part of a neighbor discovery message used in IPv6 or in addition to messages used for neighbor solicitation and advertisement.

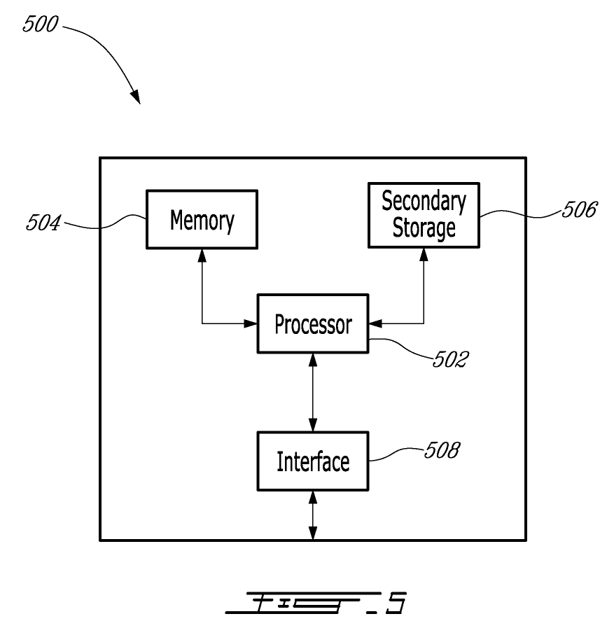

The exemplary embodiments described above provide for messages and protocols involving media communications. An exemplary server (or node) 500 will now be described with respect to FIG. 5. Server 500 can contain a processor 502 (or multiple processor cores), memory 504, one or more secondary storage devices 506 and an interface unit 508 to facilitate communications between network node 500 and the rest of the network. The memory (or the secondary storage) can be used for storage of exemplary items such as a subscriber's whitelist or other information related to the providing of services to an end user in an IMS-IPTV application. Thus, a network node, such as a DSLAM 304 or a Resource Manager 306, according to an exemplary embodiment may include, among other elements, a processor for transmitting, receiving and storing messages including media communications regarding the channel filtering information for a subscriber.

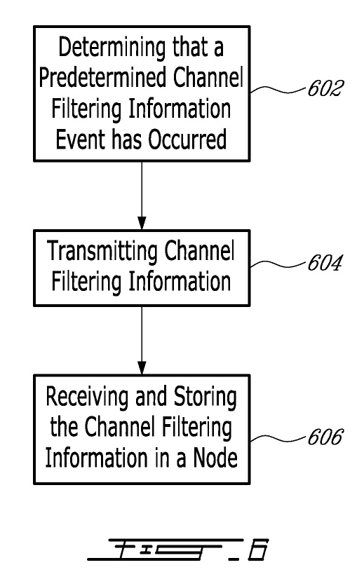

Utilizing the above described exemplary systems, according to exemplary embodiments a method for communicating channel filtering information for IPTV is shown in FIG. 6. Initially, it is determined that a predetermined channel filtering information event has occurred in step 602. These events can include, for example, receipt of a SIP invite message from a first-time power up of an IPTV client or an internal message or flag representing a change in the channel offerings provided by a particular service provider. Transmitting, responsive to the determining, from an IPTV application server, the channel filtering information in step 604. And finally, receiving and storing the channel filtering information in a node of the IPTV system in step 606.

A number of variations on the foregoing exemplary embodiments are also contemplated. For example, other actions can be used to trigger a whitelist update, e.g., movement of subscriber location or presence of a subscriber at a new location could result in a whitelist update being performed as described above. Additionally, although the foregoing illustrative examples are provided in terms of IPTV services the present invention is not so limited and can be practiced to facilitate and control the distribution of many streaming media services which can use unicast, broadcast or multicast techniques, e.g., Internet Radio or other services which are subscription based.

The above-described exemplary embodiments are intended to be illustrative in all respects, rather than restrictive, of the present invention. Thus the present invention is capable of many variations in detailed implementation that can be derived from the description contained herein by a person skilled in the art, such as instead of storing the whitelist in a DSLAM, the whitelist could be stored in other nodes in the transport plane, preferably close to the subscriber connection point. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for communicating channel filtering information for a streaming media system comprising:
determining that a predetermined channel filtering information event has occurred;
transmitting, responsive to said determining, from a streaming media application server, said channel filtering information; and
receiving and storing said channel filtering information in a node of said streaming media system.

2. The method of claim 1, wherein said predetermined channel filtering information event is at least one of: a first initialization of a subscriber's whitelist, a change to said subscriber's whitelist, a change in presence information associated with a subscriber and a change in location of a subscriber.

3. The method of claim 1, wherein said channel filtering information includes at least one of: DSL port information and IP multicast range information associated with streaming media channels.

4. The method of claim 1, wherein said node is one of a digital subscriber line access multiplexer (DSLAM) and a resource manager, and further wherein said channel filtering information is used to permit access by an end user to a subset of available streaming media channels.

5. The method of claim 1, wherein said channel filtering information is associated with one of a consumer premise equipment and a subscriber.

6. The method of claim 1, wherein said determining that a predetermined channel filtering information event has occurred further comprises:
determining that available service options have changed.

7. The method of claim 1, wherein said determining that a predetermined channel filtering information event has occurred further comprises:
receiving a Session Initiation Protocol (SIP) INVITE message transmitted by a streaming media client device at startup.

8. The method of claim 1, wherein said node receives said channel filtering information in an UPDATE message.

9. The method of claim 1, wherein said node receives said channel filtering information in a SIP 200 OK message.

10. The method of claim 1, wherein said streaming media system is one of an Internet Protocol Television (IPTV) system and an Internet Radio system.

11. A node comprising:
a processor in communications with a memory unit, wherein said processor receives a message including channel filtering information and stores said channel filtering information in said memory unit.

12. The node of claim 11, wherein said channel filtering information is a subscriber's whitelist wherein said subscriber's whitelist is a list of authorized channels which is a subset of all available channels.

13. The node of claim 11, wherein said channel filtering information includes at least one of: DSL port information and IP multicast range information associated with streaming media channels.

14. The node of claim 11, wherein said channel filtering information is associated with one of a consumer premise equipment and a subscriber.

15. The node of claim 11, wherein said node is a digital subscriber line access multiplexer (DSLAM) and further wherein said channel filtering information is used to permit access by an end user to a subset of available streaming media channels.

16. The node of claim 11, wherein said node is a resource manager and further wherein said channel filtering information is used to permit access by an end user to a subset of available streaming media channels.

17. The node of claim 11, wherein said node receives said channel filtering information in an UPDATE message.

18. The node of claim 11, wherein said node receives said channel filtering information in a SIP 200 OK message.

19. A node comprising:
a processor in communications with a memory unit, wherein said processor receives an indication that a predetermined channel filtering information event has occurred, further wherein said processor transmits a message including channel filtering information.

20. The node of claim 19, wherein said predetermined channel filtering information event is at least one of: a first initialization of a subscriber's whitelist or a change to said subscriber's whitelist, a change in presence information associated with a subscriber and a change in location of a subscriber.

21. The node of claim 19, wherein said whitelist is a list of authorized channels which is a subset of all available channels.

22. The node of claim 19, wherein said node is an IPTV application server.

23. The node of claim 19, wherein said channel filtering information is associated with one of a consumer premise equipment and a subscriber and is usable to permit said one of said consumer premise equipment and said subscriber to access a subset of available streaming media channels.

24. The node of claim 19, wherein said indication that a predetermined channel filtering information event has occurred further comprises an indication that available service options have changed.

25. The node of claim 19, wherein said indication that a predetermined channel filtering information event has occurred further comprises receipt of a Session Initiation Protocol (SIP) INVITE message.

26. The node of claim 19, wherein said node transmits said channel filtering information in an UPDATE message.

27. The node of claim 18, wherein said node transmits said channel filtering information in a SIP 200 OK message.
